(19) United States
(12) Patent Application Publication
(10) Pub. No.: US 2021/0124928 A1
(43) Pub. Date: Apr. 29, 2021

(54) OBJECT TRACKING METHODS AND APPARATUSES, ELECTRONIC DEVICES AND STORAGE MEDIA

(71) Applicant: Beijing Sensetime Technology Development Co., Ltd., Beijing (CN)

(72) Inventors: Qiang WANG, Beijing (CN); Zheng ZHU, Beijing (CN); Bo LI, Beijing (CN); Wei WU, Beijing (CN)

(21) Appl. No.: 17/102,579

(22) Filed: Nov. 24, 2020

Related U.S. Application Data
(63) Continuation of application No. PCT/CN2019/099001, filed on Aug. 2, 2019.

(30) Foreign Application Priority Data
Aug. 7, 2018 (CN) 201810893022.3

(51) Int. Cl. G06K 9/00; G06K 9/62; G06T 7/246

(52) U.S. Cl. CPC G06K 9/00711; G06T 2207/10016; G06T 7/248; G06K 9/6215

(57) ABSTRACT

Embodiments of the present disclosure disclose an object tracking method and apparatus, electronic device and storage medium. The method includes: detecting, according to a target object in a reference frame image in a video, at least one candidate object in a current frame image in the video; obtaining an interference object in at least one previous frame image in the video; adjusting filtering information of the at least one candidate object according to the obtained interference object; and determining one of the at least one candidate object whose filtering information satisfies a predetermined condition as the target object in the current frame image. The embodiments of the present disclosure can improve the discriminative ability of object tracking.

The present disclosure is a continuation of International Application No. PCT/CN2019/099001, filed on Aug. 2, 2019, which claims priority to Chinese Patent Application No. CN 201810893022.3, filed to Chinese Patent Office on Aug. 7, 2018 and entitled “OBJECT TRACKING METHODS AND APPARATUSES, ELECTRONIC DEVICES AND STORAGE MEDIA, which is incorporated herein by reference in its entirety.

### TECHNICAL FIELD

The present disclosure relates to computer vision technology, and in particular, to an object tracking method and apparatus, an electronic device, and a storage medium.

### BACKGROUND

Target tracking is one of the hotspots of computer vision research, which has a wide range of applications in many fields, such as: tracking focus of a camera, automatic target tracking of an unmanned aerial vehicle, human body tracking, vehicle tracking in a traffic monitoring system, human face tracking, gesture tracking in an intelligent interaction system, etc.

### SUMMARY

The embodiments of the present disclosure provide a technical solution for object tracking.

According to an aspect of the embodiments of the present disclosure, an object tracking method is provided, which includes:

detecting, according to a target object in a reference frame image in a video, at least one candidate object in a current frame image in the video;

obtaining an interference object in at least one previous frame image in the video;

adjusting filtering information of the at least one candidate object according to the obtained interference object; and

determining one of the at least one candidate object whose filtering information satisfies a predetermined condition as the target object in the current frame image.

According to another aspect of the embodiments of the present disclosure, an object tracking apparatus, which includes:

a detecting unit, configured to detect at least one candidate object in a current frame image in a video according to a target object in a reference frame image in the video;

an obtaining unit, configured to obtain an interference object in at least one previous frame image in the video;

an adjustment unit, configured to adjust filtering information of the at least one candidate object according to the obtained interference object; and

a determining unit, configured to determine one of the at least one candidate object whose filtering information satisfies a predetermined condition as the target object in the current frame image.

According to still another aspect of the embodiments of the present disclosure, an electronic device is provided, which includes the apparatus according to any of the above embodiments.

According to still another aspect of the embodiments of the present disclosure, an electronic device is provided, which includes:

a memory storing executable instructions; and

a processor configured to execute the executable instructions to complete the method according to any one of the above embodiments.

According to still another aspect of the embodiments of the present disclosure, a computer program including computer readable codes is provided, when the computer readable codes run on a device, a processor in the device is caused to execute instructions for implementing the method according to any one of the above embodiments.

According to still another aspect of the embodiments of the present disclosure, a computer storage medium for storing computer readable instructions, when the computer-readable instructions are executed, the method according to any one of the above embodiments is implemented.

Based on the object tracking method and apparatus, electronic device, computer program and storage medium provided in the above embodiments of the present disclosure, according to a target object in a reference frame image in a video, at least one candidate object in a current frame image in the video is detected; an interference object in at least one previous frame image in the video are obtained; filtering information of the at least one candidate object is adjusted according to the obtained interference object; and one of the at least one candidate object whose filtering information satisfies a predetermined condition is determined as the target object in the current frame image. During object tracking in embodiments of the present disclosure, by using the interference object in the previous frame image before the current frame image, filtering information of the candidate objects is adjusted. When the filtering information of the candidate objects is used to determine the target object in the current frame image, an interference object in the candidate objects can be effectively suppressed and the target object is obtained from the candidate objects. In the process of determining the target object in the current frame image, the influence of interference objects around the target object on the determination result can be effectively suppressed, and thus the discrimination ability of target object tracking can be improved.

The technical solutions of the present disclosure will be further described in detail below through the accompanying drawings and embodiments.

### BRIEF DESCRIPTION OF THE DRAWINGS

The accompanying drawings, which form a part of the description, describe embodiments of the present disclosure, and together with the description serve to explain the principles of the present disclosure.

The present disclosure can be more clearly understood from the following detailed description with reference to the accompanying drawings.

FIG. 1 is a flowchart of an object tracking method according to some embodiments of the present disclosure;

FIG. 2 is a flowchart of an object tracking method according to some embodiments of the present disclosure;

FIG. 3 is a flowchart of an object tracking method according to some embodiments of the present disclosure;

FIGS. 4A to 4C are schematic diagrams of an application example of an object tracking method according to some embodiments of the present disclosure;

FIGS. 4D and 4E are schematic diagrams of another application example of an object tracking method according to some embodiments of the present disclosure;

FIG. 5 is a schematic structural diagram of an object tracking apparatus according to some embodiments of the present disclosure;

FIG. 6 is a schematic structural diagram of an object tracking apparatus according to some embodiments of the present disclosure; and

FIG. 7 is a schematic structural diagram of an electronic device provided by some embodiments of the present disclosure.

### DETAILED DESCRIPTION OF THE EMBODIMENTS

Various exemplary embodiments of the present disclosure will now be described in detail with reference to the accompanying drawings. It should be noted that the relative arrangements, numerical expressions, and numerical values of the components and steps set forth in these embodiments do not limit the scope of the present disclosure unless otherwise specified.

It should also be understood that in the embodiments of the present disclosure, “a plurality of” may refer to two or more, and “at least one” may refer to one, two or more.

Persons skilled in the art may understand that the terms such as “first” and “second” in the embodiments of the present disclosure are merely used to distinguish different steps, devices, or modules, or the like, and neither represent any particular technical meaning nor represent the necessary logical order therebetween.

It should also be understood that any component, data, or structure mentioned in the embodiments of the present disclosure may generally be understood as one or more of the components, data, or structures without expressly defining or giving the opposite motivation in the context.

It should also be understood that the description of various embodiments of the present disclosure focuses on emphasizing differences between various embodiments, and the same or similar parts may be referred to each other. For simplicity, the same or similar parts will not be described herein again.

Meanwhile, it should be understood that, for convenience of description, the dimensions of the various parts shown in the drawings are not drawn according to actual proportional relationships.

The following description of at least one exemplary embodiment is practically merely illustrative, and is not intended to limit the present disclosure and its application or use.

Techniques, methods, and devices known to those of ordinary skill in the relevant art may not be discussed in detail, but where appropriate, the techniques, methods, and devices should be considered as part of the description.

It should be noted that like reference signs and letters denote like items in the following figures, and therefore, once a certain item is defined in one figure, no further discussion thereof is needed in the following figures.

In addition, the term “and/or” in the present disclosure is merely an association relationship for describing associated objects, and indicates that there may be three relationships, for example, A and/or B may indicate that there are three cases: A alone, both A and B, and B alone. In addition, the character “/” in the present disclosure generally indicates that the front and back associated objects are a relationship of “or”.

Embodiments of the present disclosure may be applied to a computer system/server, which may operate with numerous other general-purpose or special-purpose computing systems, environments or configurations. Examples of well-known computing systems, environments and/or configurations suitable for use with the computer system/server include, but not limited to, personal computer systems, server computer systems, thin clients, thick clients, hand-held or laptop devices, microprocessor-based systems, set-top boxes, programmable consumer electronics, network personal computers, minicomputer systems, mainframe computer systems, and distributed cloud computing technology environments including any of the above, and the like.

The computer system/server may be described in the general context of computer system-executable instructions, such as program modules, executed by the computer system. In general, program modules may include routines, programs, target programs, components, logic, data structures, etc. that perform particular tasks or implement particular abstract data types. The computer system/server may be implemented in a distributed cloud computing environment in which tasks are performed by a remote processing device linked through a communication network. In the distributed cloud computing environment, the program modules may be located on a storage medium of a local or remote computing system including a storage device.

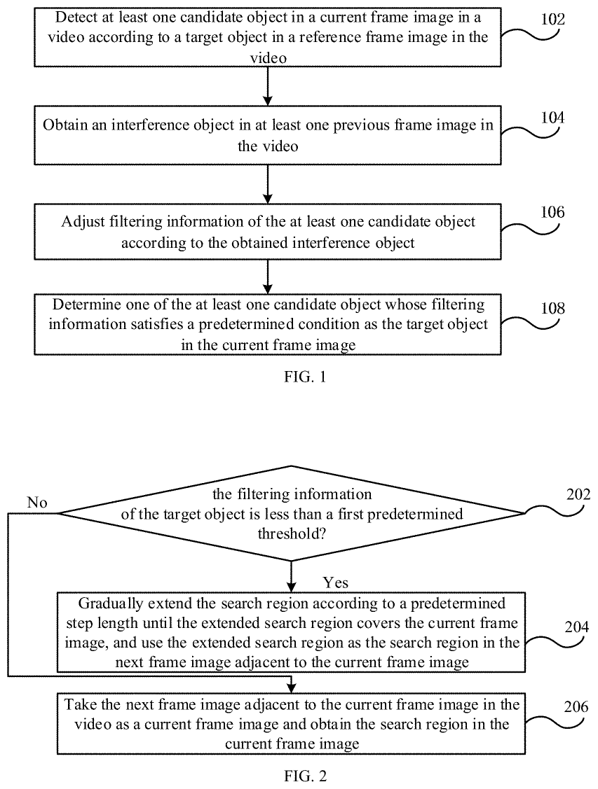

FIG. 1 is a flowchart of an object tracking method according to some embodiments of the present disclosure. As shown in FIG. 1, the method includes operations 102-108.

At operation 102, at least one candidate object in a current frame image in a video is detected according to a target object in a reference frame image in the video.

In this embodiment, the video for object tracking can be a video obtained from a video capture device. For example, the video capture device can include a video camera, a pickup head and so on. The video for object tracking can also be a video obtained from a storage device. For example, the storage device can include an optical disk, a hard disk, a U disk, etc. The video for object tracking can also be a video obtained from a network server. The manner of obtaining the video to be processed is not limited in this embodiment. The reference frame image can be the first frame image in the video. The reference frame image can also be the first frame image for performing object tracking processing on the video. The reference frame image can also be an intermediate frame image in the video. The selection of the reference frame image is not limited in this embodiment. The current frame image can be a frame image other than the reference frame image in the video, and can be before or after the reference frame image, which is not limited in this embodiment. In an optional example, the current frame image in the video is after the reference frame image.

Optionally, a correlation between an image of the target object in the reference frame image and the current frame image can be determined, and bounding boxes and filtering information of the at least one candidate object in the current frame image can be obtained according to the correlation. In an optional example, the correlation between the image of the target object in the reference frame image and the current frame image can be determined according to a first feature of the image of the target object in the reference frame image and a second feature of the current frame image. For example, the correlation is obtained by convolution processing. This embodiment does not limit the manner of determining the correlation between the image of the target object in the reference frame image and the current frame image. The bounding box of the candidate object may be obtained by, for example, non-maximum suppression (NMS). The filtering information of the candidate object may be, for example, information such as a score of the bounding box of the candidate object, a probability of selecting the candidate object and so on. This embodiment does not limit the manner of obtaining the bounding box and filtering information of the candidate object based on the correlation.

In an optional example, the operation 102 can be executed by the processor invoking corresponding instructions stored in the memory, or can be executed by a detecting unit operated by the processor.

At operation 104, an interference object in at least one previous frame image in the video is obtained.

In this embodiment, the at least one previous frame image can include: the reference frame image, and/or at least one intermediate frame image located between the reference frame image and the current frame image.

Optionally, the interference object in at least one previous frame image in the video can be obtained according to a predetermined interference object set. By predetermining an interference object set, when performing object tracking processing on each frame image in the video, one or more of the at least one candidate object that is not determined as the target object is determined as interference objects in the current frame image, and put into the interference object set. In an optional example, one or more of the at least one candidate object that is not determined as the target object and whose filtering information satisfies a predetermined interference object condition can be determined as interference objects and put into the interference object set. For example, the filtering information is a score of a bounding box, and the predetermined interference object condition can be that the score of the bounding box is greater than a predetermined threshold.

In an optional example, interference objects in all previous frame images in the video can be obtained.

In an optional example, the operation 104 can be executed by the processor invoking corresponding instructions stored in the memory, or can be executed by an obtaining unit operated by the processor.

At operation 106, filtering information of the at least one candidate object is adjusted according to the obtained interference object.

Optionally, for each of the at least one candidate object, a first similarity between the candidate object and the obtained interference object can be determined, and the filtering information of the candidate object can be adjusted according to the first similarity. In an optional example, the first similarity between the candidate object and the obtained interference object can be determined based on a feature of the candidate object and a feature of the obtained interference object. In an optional example, the filtering information is the score of the bounding box. When the first similarity between the candidate object and the obtained interference object is relatively high, the score of the bounding box of the candidate object may be decreased, and when the first similarity between the candidate object and the obtained interference object is relatively low, the score of the bounding box of the candidate object may be increased or the score may be kept unchanged.

Optionally, when the number of obtained interference objects is more than one, a weighted average of similarities between the candidate object and all the obtained interference objects can be calculated, and the weighted average is used to adjust the filtering information of the candidate object. The weight of each interference object in the weighted average is related to the degree of interference by which the interference object is interfered with the target object selection. For example, the greater the degree of interference by which the interference object is interfered with the target object selection, the greater the weight of the interference object. In an optional example, the filtering information is the score of the bounding box, and a correlation coefficient between the candidate object and the obtained interference object can be used to indicate the first similarity between the candidate object and the obtained interference object. A difference between a correlation coefficient between the target object in the reference frame image and the candidate object and the weighted average of the first similarities between the candidate object and the obtained interference objects is used to adjust the score of the bounding box of the candidate object.

In an optional example, the operation 106 can be executed by the processor invoking corresponding instructions stored in the memory, or can be executed by an adjustment unit operated by the processor.

At operation 108, one of the at least one candidate object whose filtering information satisfies a predetermined condition is determined as the target object in the current frame image.

Optionally, the bounding box of the candidate object whose filtering information satisfies the predetermined condition can be determined to be the bounding box of the target object in the current frame image. In an optional example, the filtering information is the score of the bounding box. The candidate objects may be ranked according to the scores of the bounding boxes of the candidate objects. The bounding box of the candidate object with the highest score is used as the bounding box of the target object in the current frame image to determine the target object in the current frame image.

Optionally, positions and shapes of the bounding boxes of the candidate objects can be compared with position and shape of a bounding box of the target object in a previous frame image adjacent to the current frame image in the video, the scores of the bounding boxes of the candidate objects in the current frame image are adjusted according to the comparison result, the adjusted scores of the bounding boxes of the candidate objects in the current frame image are re-ranked, and the bounding box of the candidate object with the highest score after re-ranking is determined as the bounding box of the target object in the current frame image. For example, compared with the previous frame image, the score of the bounding box of the candidate object whose position shift is relatively large and shape change is relatively large is decreased.

Optionally, after determining the bounding box of the candidate object whose filtering information satisfies the predetermined condition as the bounding box of the target object in the current frame image, the bounding box of the target object can further be displayed in the current frame image to mark the position of the target object in the current frame image.

In an optional example, the operation 108 can be executed by the processor invoking corresponding instructions stored in the memory, or can be executed by a determining unit operated by the processor.

Based on the object tracking method provided in this embodiment, according to a target object in a reference frame image in a video, at least one candidate object in a current frame image in the video is detected; an interference object in at least one previous frame image in the video are obtained; filtering information of the at least one candidate object is adjusted according to the obtained interference object; and one of the at least one candidate object whose filtering information satisfies a predetermined condition is determined as the target object in the current frame image. During object tracking, by using the interference object in the previous frame image before the current frame image, filtering information of the candidate objects is adjusted. When the filtering information of the candidate objects is used to determine the target object in the current frame image, an interference object in the candidate objects can be effectively suppressed and the target object is obtained from the candidate objects. In the process of determining the target object in the current frame image, the influence of interference objects around the target object on the determination result can be effectively suppressed, and thus the discrimination ability of object tracking can be improved.

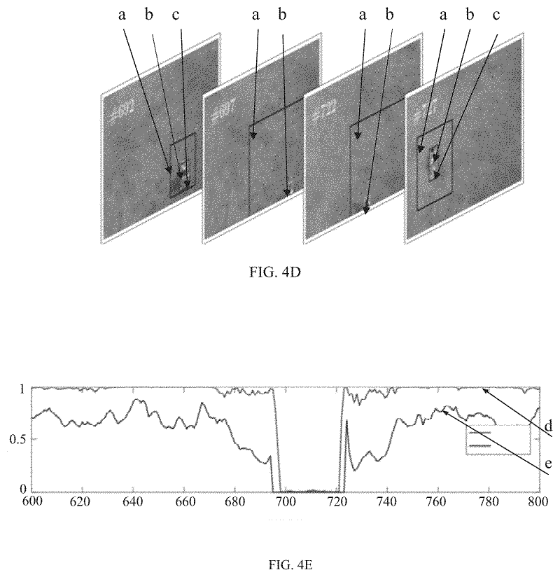

FIGS. 4A to 4C are schematic diagrams of an application example of the object tracking method according to some embodiments of the present disclosure. As shown in FIGS. 4A to 4C, FIG. 4A is the current frame image in the to-be-processed video for object tracking. In FIG. 4A, boxes a, b, d, e, f and g are bounding boxes of candidate objects in the current frame image, and box c is the bounding box of the target object in the current frame image. FIG. 4B is a schematic diagram of scores of bounding boxes of candidate objects in the current frame image obtained by using an existing object tracking method. From FIG. 4B, it can be seen that the target object that we expect to obtain the highest score, that is, the target object corresponding to the box c, did not get the highest score due to the influence of the interference objects. FIG. 4C is a schematic diagram of scores of bounding boxes of candidate objects in the current frame image obtained by using the object tracking method provided by some embodiments of the present disclosure. From FIG. 4C, it can be seen that the target object that we expect to obtain the highest score, that is, the target object corresponding to the box c, has got the highest score, and the scores of the interference objects around the box c are suppressed.

In some embodiments, the object tracking method can further include obtaining the target object in at least one intermediate frame image between the reference frame image and the current frame image in the video, and optimizing the filtering information of at least one candidate object according to the target object in the at least one intermediate frame image. In an optional example, for each of the at least one candidate object, a second similarity between the candidate object and the target object in the at least one intermediate frame image can be determined, and then the filtering information of the candidate object can be optimized according to the second similarity. For example, the second similarity between the candidate object and the target object in the at least one intermediate frame image can be determined based on a feature of the candidate object and a feature of the target object in the at least one intermediate frame image.

Optionally, the target object can be obtained from at least one intermediate frame image in which the target object has been determined and between the reference frame image and the current frame image in the video. In an optional example, the target object in all intermediate frame images in which the target object has been determined and between the reference frame image and the current frame image in the video can be obtained.

Optionally, when the number of obtained target objects is more than one, a weighted average of similarities between the candidate object and all obtained target objects can be calculated, and the weighted average is used to optimize the filtering information of the candidate object. The weight of each target object in the weighted average is related to the degree of influence by which the target object affects the target object selection in the current frame image. For example, the weight of the target object in a frame image that is closer to the current frame image is also larger. In an optional example, the filtering information is the score of the bounding box, and a correlation coefficient between the candidate object and the obtained interference object can be used to indicate the first similarity between the candidate object and the obtained interference object. The score of the bounding box of the candidate object can be adjusted through a correlation coefficient between the target object in the reference frame image and the candidate object, and a difference between the weighted average of second similarities between the candidate object and the obtained target objects and the weighted average of first similarities between the candidate object and the obtained interference objects.

In this embodiment, the obtained target object in an intermediate frame image between the reference frame image and the current frame image in the video is used to optimize the filtering information of the candidate objects, so that the obtained filtering information of the candidate objects in the current frame image can reflect the attributes of the candidate objects more realistically. In this way, a more accurate determination result can be obtained when determining the position of the target object in the current frame image in the video to be processed.

In some embodiments, before detecting at least one candidate object in the current frame image in the video according to the target object in the reference frame image in the video in operation 102, a search region in the current frame image can further be obtained to improve the calculation speed. At operation 102, within the search region in the current frame image and according to the target object in the reference frame image in the video, at least one candidate object in the current frame image in the video is detected. For the operation of obtaining the search region in the current frame image, the region where the target object may appear in the current frame image can be estimated and assumed with a predetermined search algorithm.

Optionally, after determining one of the at least one candidate object whose filtering information satisfies the predetermined condition as the target object in the current frame image at operation 108, a search region in a next frame image adjacent to the current frame image in the video can be determined according to filtering information of the target object in the current frame image. The process of determining the search region in the next frame image adjacent to the current frame image in the video according to the filtering information of the target object in the current frame image will be described in detail below in conjunction with FIG. 2. As shown in FIG. 2, the process includes operations 202-206.

At operation 202, it is detected whether the filtering information of the target object is less than a first predetermined threshold.

Optionally, the first predetermined threshold can be determined through statistics according to the filtering information of the target object and a state of the target object being blocked (i.e, obstructed) or leaving the field of view. In an optional example, the filtering information is the score of the bounding box of the target object.

If the filtering information of the target object is less than the first predetermined threshold, perform operation 204; and/or, if the filtering information of the target object is greater than or equal to the first predetermined threshold, perform operation 206.

At operation 204, the search region is gradually extended according to a predetermined step length until the extended search region covers the current frame image, and the extended search region is used as the search region in the next frame image adjacent to the current frame image.

Optionally, after operation 204, the next frame image adjacent to the current frame image in the video can be used as a current frame image, and the target object in the current frame image is determined in the extended search region.

At operation 206, the next frame image adjacent to the current frame image in the video is taken as a current frame image and the search region in the current frame image is obtained.

Optionally, after taking the next frame image adjacent to the current frame image in the video as the current frame image and obtaining the search region in the current frame image, the target object in the current frame image may be determined within the search region in the current frame image.

In an optional example, the operations 202-206 can be executed by the processor invoking the corresponding instructions stored in the memory, or can be executed by a search unit operated by the processor.

In this embodiment, the filtering information of the target object in the current frame image is compared with the first predetermined threshold. When the filtering information of the target object in the current frame image is less than the first predetermined threshold, the search region is extended until the extended search region covers the current frame image. When the target object in the current frame image for object tracking is blocked or the target object in the current frame image for object tracking leaves the field of view, the extended search region which is the same as the current frame image can be used to cover the entire current frame image, and when performing object tracking in the next frame image, the extended search region is used to cover the entire next frame image. When the target object appears in the next frame image, because the extended search region covers the entire next frame image, a situation in which the target object cannot be tracked since the target object appears outside the search region does not occur, and thus long-term tracking the target object can be realized.

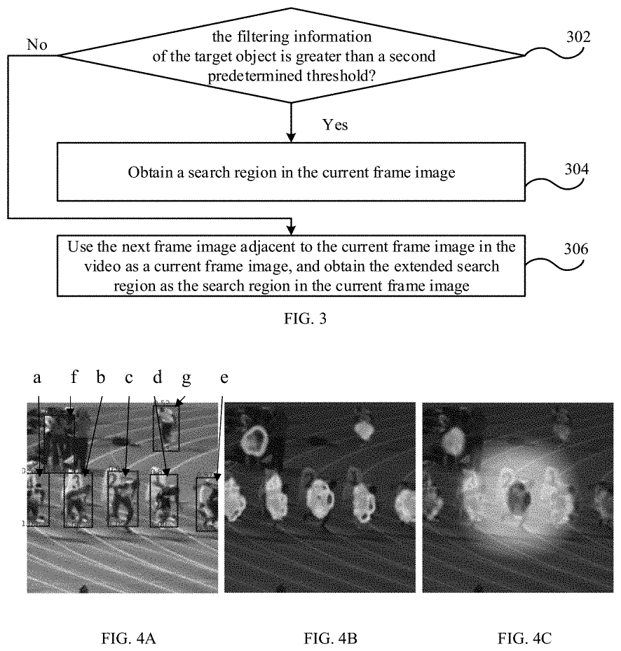

In some embodiments, after gradually extending the search region according to the predetermined step length until the extended search region covers the current frame image at operation 204, the next frame image adjacent to the current frame image in the video may be used as a current frame image, the extended search region is used as a search region in the current frame image, and the target object in the current frame image is determined within the extended search region. Moreover, according to the filtering information of the target object in the current frame image, it can be determined whether the search region in the current frame image is restored. The process of determining whether the search region in the current frame image is restored according to the filtering information of the target object in the current frame image will be described in detail below in conjunction with FIG. 3. As shown in FIG. 3, the process includes operations 302-306.

At operation 302, it is detected whether the filtering information of the target object is greater than a second predetermined threshold.

The second predetermined threshold is greater than the first predetermined threshold, and the second predetermined threshold can be determined through statistics according to the filtering information of the target object and the state of the target object not being obscured or not leaving the field of view.

If the filtering information of the target object is greater than the second predetermined threshold, perform operation 304; and/or, if the filtering information of the target object is less than or equal to the second predetermined threshold, perform operation 306.

At operation 304, a search region in the current frame image is obtained.

Optionally, after operation 304, the target object in the current frame image is determined within the search region in the current frame image.

At operation 306, the next frame image adjacent to the current frame image in the video is used as a current frame image, and the extended search region is obtained as the search region in the current frame image.

After taking the next frame image adjacent to the current frame image in the video as the current frame image and obtaining the extended search region as the search region in the current frame image, the target object in the current frame image can further be determined within the extended search region.

In an optional example, the operations 302-306 can be executed by the processor invoking the corresponding instructions stored in the memory, or can be executed by the search unit operated by the processor.

In this embodiment, when performing object tracking on the next frame image after the search region is extended according to the filtering information of the target object in the current frame image, the next frame image is taken as a current frame image, then the filtering information of the target object in the current frame image is compared with the second predetermined threshold, when the filtering information of the target object in the current frame image is greater than the second predetermined threshold, the search region in the current frame image is obtained, and the target object in the current frame image is determined within the search region. When the target object in the current frame image for object tracking is not blocked and the target object in the current frame image does not leave the field of view, the original object tracking method can be restored, that is, the predetermined search algorithm is used to obtain the search region in the current frame image for object tracking, thereby reducing the amount of data processing and increasing the calculation speed.

FIGS. 4D and 4E are schematic diagrams of another application example of the object tracking method according to some embodiments of the present disclosure. As shown in FIG. 4D and FIG. 4E, FIG. 4D shows four frame images in the video for object tracking. In FIG. 4D, the sequence numbers of the four frame images are 692, 697, 722 and 727 respectively. Box a indicates a search box for determining a search region in the current frame image, box b represents a true outline of the target object, and box c indicates a bounding box for target tracking. From FIG. 4D, it can be seen that the target object in the two-frame images represented by 697 and 722 are not within the field of view, and thus the search region is extended. In this way, the target object in the two-frame images represented by 697 and 722 re-enters within the field of view, and thus the search region is restored to a normal search region. FIG. 4E is a schematic diagram illustrating a change of the scores of the target object in FIG. 4D and a change of the overlap of the target object and the bounding box. Line d represents the change of the scores of the target object. Line e represents the overlap between the target object and the bounding box. From FIG. 4E, it can be seen that the score of the target object is rapidly decreased at 697. Meanwhile, the overlap between the target object and the bounding box is rapidly decreased at 697. The score of the target object has recovered to a larger value at 722. The overlap between the target object and the bounding box is also rapidly increased at 722. Therefore, the problem existing in object tracking when the target object is not in the field of view range or blocked can be improved by determining the score of the target object.

In some embodiments, after determining one of the at least one candidate object whose filtering information satisfies a predetermined condition as the target object in the current frame image at operation 108, a category of the target object in the current frame image can further be identified, which can enhance the function of object tracking and increase the application scenarios of object tracking.

In some embodiments, the object tracking method of the foregoing embodiments can be executed by a neural network.

Optionally, before executing the object tracking method, the neural network can be trained according to sample images. The sample images used for training the neural network may include positive samples and negative samples, where the positive samples include: positive sample images in a predetermined training data set and positive sample images in a predetermined test data set. For example, the predetermined training data set can use video sequences on Youtube BB and VID, and the predetermined test data set can use detection data from ImageNet and COCO. In this embodiment, by using positive sample images in the test data set to train the neural network, the types of positive samples can be increased, thereby ensuring the generalization performance of the neural network and improving the discrimination ability of object tracking.

Optionally, in addition to including the positive sample images in the predetermined training data set and the positive sample images in the predetermined test data set, the positive samples may further include: positive sample images obtained by performing data enhancement processing on the positive sample images in the predetermined test data set. For example, in addition to conventional data enhancement processing such as translation, scale change, and light change, data enhancement processing, such as motion blur, for a particular motion mode can be adopted. The manner of data enhancement processing is not limited in this embodiment. In this embodiment, the neural network is trained with positive sample images obtained by performing data enhancement processing on the positive sample images in the test data set, which can increase the diversity of positive sample images, improve the robustness of the neural network, and avoid overfitting.

Optionally, negative samples can include: a negative sample image of an object having the same category as the target object and/or a negative sample image of an object having different category from the target object. For example, the negative sample image obtained from the positive sample images in the predetermined test data set can be a background image around the target object in the positive sample image from the predetermined test data set. In this case, these two types of negative sample images usually have no semantics. The negative sample image of an object having the same category as the target object can be a frame image randomly extracted from other videos or images, and the object in the frame image has the same category as the target object in the positive sample image. The negative sample image of an object having a different category from the target object can be a frame image randomly extracted from other videos or images, and the object in the frame image has a different category from the target object in the positive sample image. In this case, these two types of negative sample images usually have semantics. In this embodiment, the neural network is trained by using the negative sample image of an object having the same category as the target object and/or the negative sample images of an object having a different category from the target object, which can ensure a balanced distribution of positive and negative sample images and improve the performance of the neural network, thereby improving the discrimination ability of object tracking.

Any object tracking method provided in the embodiments of the present disclosure can be executed by any suitable device with data processing capabilities, including but not limited to: terminal devices and servers. Alternatively, any object tracking method provided in the embodiments of the present disclosure may be executed by a processor, for example, the processor executes any object tracking method mentioned in the embodiments of the present disclosure by invoking corresponding instructions stored in a memory. The details are not described below.

A person of ordinary skill in the art can understand that all or part of the steps in the above method embodiments can be implemented by a hardware associated with program instructions. The foregoing program can be stored in a computer readable storage medium, and when the program is executed, the steps of the foregoing method embodiment are performed. The foregoing storage medium includes: various media that can store program codes, such as a a Read Only Memory (ROM), a Random Access Memory (RAM), a magnetic disk, or an optical disk.

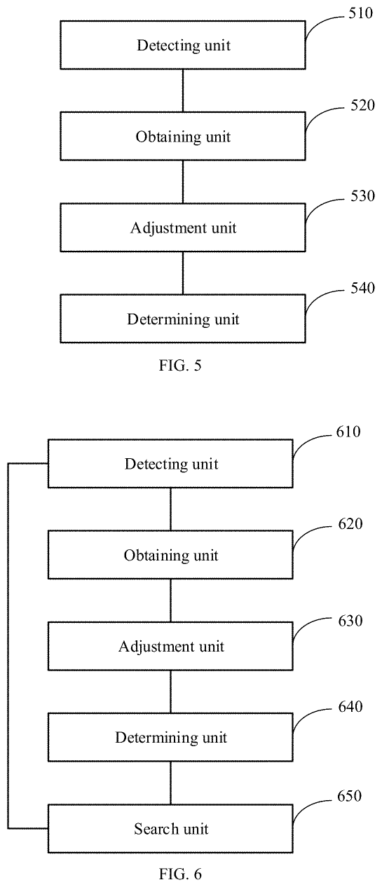

FIG. 5 is a flowchart of an object tracking apparatus according to some embodiments of the present disclosure. As shown in FIG. 5, the apparatus includes: a detecting unit 510, an obtaining unit 520, an adjustment unit 530, and a determining unit 540.

The detecting unit 510 is configured to detect at least one candidate object in a current frame image in a video according to a target object in a reference frame image in the video.

In this embodiment, the video for object tracking can be a video obtained from a video capture device. For example, the video capture device can include a video camera, a pickup head and so on. The video for object tracking can also be a video obtained from a storage device. For example, the storage device can include an optical disk, a hard disk, a U disk, etc. The video for object tracking can also be a video obtained from a network server. The manner of obtaining the video to be processed is not limited in this embodiment. The reference frame image can be the first frame image in the video. The reference frame image can also be the first frame image for performing object tracking processing on the video. The reference frame image can also be an intermediate frame image in the video. The selection of the reference frame image is not limited in this embodiment. The current frame image can be a frame image other than the reference frame image in the video, and can be before or after the reference frame image, which is not limited in this embodiment. In an optional example, the current frame image in the video is after the reference frame image.

Optionally, the detecting unit 510 can determine a correlation between an image of the target object in the reference frame image and the current frame image, and obtains bounding boxes and filtering information of the at least one candidate object in the current frame image according to the correlation. In an optional example, the detecting unit 510 can determine the correlation between the image of the target object in the reference frame image and the current frame image according to a first feature of the image of the target object in the reference frame image and a second feature of the current frame image. For example, the correlation is obtained by convolution processing. This embodiment does not limit the manner of determining the correlation between the image of the target object in the reference frame image and the current frame image. The bounding box of the candidate object may be obtained by, for example, non-maximum suppression (NMS). The filtering information of the candidate object is information related to the nature of the candidate object itself, and the candidate object may be distinguished from other candidate objects according to the information. For example, the filtering information of the candidate information can be information such as a score of the bounding box of the candidate object, a probability of selecting the candidate object and so on. The score of the bounding box and the probability of selection can be a correlation coefficient of the candidate object obtained according to the correlation. This embodiment does not limit the manner of obtaining the bounding box and filtering information of the candidate object based on the correlation.

The obtaining unit 520 is configured to obtain an interference object in at least one previous frame image in the video.

In this embodiment, the at least one previous frame image may include: the reference frame image, and/or at least one intermediate frame image located between the reference frame image and the current frame image.

Optionally, the obtaining unit 520 can obtain the interference object in at least one previous frame image in the video according to a predetermined interference object set. By predetermining an interference object set, when performing object tracking processing on each frame image in the video, one or more of the at least one candidate object that is not determined as the target object is determined as interference objects in the current frame image, and put into the interference object set. In an optional example, one or more of the at least one candidate object that is not determined as the target object and whose filtering information satisfies a predetermined interference object condition can be determined as interference objects and put into the interference object set. For example, the filtering information is a score of a bounding box, and the predetermined interference object condition can be that the score of the bounding box is greater than a predetermined threshold.

In an optional example, the obtaining unit 520 may obtain interference objects in all previous frame images in the video.

The adjustment unit 530 is configured to adjust filtering information of at least one candidate object according to the obtained interference object.

Optionally, for each of the at least one candidate object, the adjustment unit 530 can determine a first similarity between the candidate object and the obtained interference object, and adjust the filtering information of the candidate object according to the first similarity. In an optional example, the adjustment unit 530 may determine the first similarity between the candidate object and the obtained interference object based on a feature of the candidate object and a feature of the obtained interference object. In an optional example, the filtering information is the score of the bounding box. When the first similarity between the candidate object and the obtained interference object is relatively high, the score of the bounding box of the candidate object may be decreased, and when the first similarity between the candidate object and the obtained interference object is relatively low, the score of the bounding box of the candidate object may be increased or the score may be kept unchanged.

Optionally, when the number of obtained interference objects is more than one, a weighted average of similarities between the candidate object and all the obtained interference objects can be calculated, and the weighted average is used to adjust the filtering information of the candidate object. The weight of each interference object in the weighted average is related to the degree of interference by which the interference object is interfered with the target object selection. For example, the greater the degree of interference by which the interference object is interfered with the target object selection, the greater the weight of the interference object. In an optional example, the filtering information is the score of the bounding box, and a correlation coefficient between the candidate object and the obtained interference object can be used to indicate the first similarity between the candidate object and the obtained interference object. A difference between a correlation coefficient between the target object in the reference frame image and the candidate object and the weighted average of the first similarities between the candidate object and the obtained interference objects is used to adjust the score of the bounding box of the candidate object.

The determining unit 540 is configured to determine one of the at least one candidate object whose filtering information satisfies a predetermined condition as the target object in the current frame image.

Optionally, the determining unit 540 can determine the bounding box of the candidate object whose filtering information satisfies the predetermined condition to be the bounding box of the target object in the current frame image. In an optional example, the filtering information is the score of the bounding box. The candidate objects may be ranked according to the scores of the bounding boxes of the candidate objects. The bounding box of the candidate object with the highest score is used as the bounding box of the target object in the current frame image to determine the target object in the current frame image.

Optionally, positions and shapes of the bounding boxes of the candidate objects can be compared with position and shape of a bounding box of the target object in a previous frame image adjacent to the current frame image in the video, the scores of the bounding boxes of the candidate objects in the current frame image are adjusted according to the comparison result, the adjusted scores of the bounding boxes of the candidate objects in the current frame image are re-ranked, and the bounding box of the candidate object with the highest score after re-ranking is determined as the bounding box of the target object in the current frame image. For example, compared with the previous frame image, the score of the bounding box of the candidate object whose position shift is relatively large and shape change is relatively large is decreased.

Optionally, the apparatus can further include: a display unit. After determining the bounding box of the candidate object whose filtering information satisfies the predetermined condition as the bounding box of the target object in the current frame image, the display unit can display the bounding box of the target object in the current frame image to mark the position of the target object in the current frame image.

Based on the object tracking apparatus provided in this embodiment, according to a target object in a reference frame image in a video, at least one candidate object in a current frame image in the video is detected; an interference object in at least one previous frame image in the video are obtained; filtering information of the at least one candidate object is adjusted according to the obtained interference object; and one of the at least one candidate object whose filtering information satisfies a predetermined condition is determined as the target object in the current frame image. During object tracking, by using the interference object in the previous frame image before the current frame image, filtering information of the candidate objects is adjusted. When the filtering information of the candidate objects is used to determine the target object in the current frame image, an interference object in the candidate objects can be effectively suppressed and the target object is obtained from the candidate objects. In the process of determining the target object in the current frame image, the influence of interference objects around the target object on the determination result can be effectively suppressed, and thus the discrimination ability of object tracking can be improved.

In some embodiments, the obtaining unit 520 can further obtain the target object in at least one intermediate frame image between the reference frame image and the current frame image in the video. The apparatus can further include an optimization unit to optimize the filtering information of at least one candidate object according to the target object in the at least one intermediate frame image. In an optional example, for each of the at least one candidate object, the optimization unit can determine a second similarity between the candidate object and the target object in the at least one intermediate frame image, and then optimize the filtering information of the candidate object according to the second similarity. For example, the optimization unit can determine the second similarity between the candidate object and the target object in the at least one intermediate frame image based on a feature of the candidate object and a feature of the target object in the at least one intermediate frame image.

Optionally, the obtaining unit 520 can acquire the target object from at least one intermediate frame image in which the target object has been determined and between the reference frame image and the current frame image in the video. In an optional example, the obtaining unit 520 can obtain the target object in all intermediate frame images in which the target object has been determined and between the reference frame image and the current frame image in the video.

Optionally, when the number of obtained target objects is more than one, a weighted average of similarities between the candidate object and all obtained target objects can be calculated, and the weighted average is used to optimize the filtering information of the candidate object. The weight of each target object in the weighted average is related to the degree of influence by which the target object affects the target object selection in the current frame image. For example, the weight of the target object in a frame image that is closer to the current frame image is also larger. In an optional example, the filtering information is the score of the bounding box, and a correlation coefficient between the candidate object and the obtained interference object can be used to indicate the first similarity between the candidate object and the obtained interference object. The score of the bounding box of the candidate object can be adjusted through a correlation coefficient between the target object in the reference frame image and the candidate object, and a difference between the weighted average of second similarities between the candidate object and the obtained target objects and the weighted average of first similarities between the candidate object and the obtained interference objects.

In this embodiment, the obtained target object in an intermediate frame image between the reference frame image and the current frame image in the video is used to optimize the filtering information of the candidate objects, so that the obtained filtering information of the candidate objects in the current frame image can reflect the attributes of the candidate objects more realistically. In this way, a more accurate determination result can be obtained when determining the position of the target object in the current frame image in the video to be processed.

FIG. 6 is a flowchart of an object tracking apparatus according to other embodiments of the present disclosure. As shown in FIG. 6, in addition to a detecting unit 610, an obtaining unit 620, an adjustment unit 630, and a determining unit 640, compared with the embodiment shown in FIG. 5, the apparatus further includes a search unit 650 to obtain a search region in the current frame image. The detecting unit 610 is configured to detect at least one candidate object in the current frame image in the video according to the target object in the reference frame image in the video and within the search region in the current frame image. For the operation of obtaining the search region in the current frame image, the region where the target object may appear in the current frame image can be estimated and assumed with a predetermined search algorithm.

Optionally, the search unit 650 is further configured to determine the search region according to the filtering information of the target object in the current frame image.

In some embodiments, the search unit 650 is configured to detect whether the filtering information of the target object is less than a first predetermined threshold; if the filtering information of the target object is less than the first predetermined threshold, gradually extend the search region according to the predetermined step length until the extended search region covers the current frame image; and/or, if the filtering information of the target object is greater than or equal to the first predetermined threshold, use the next frame image adjacent to the current frame image in the video is used as the current frame image and obtain the search region in the current frame image.

In this embodiment, the filtering information of the target object in the current frame image is compared with the first predetermined threshold. When the filtering information of the target object in the current frame image is less than the first predetermined threshold, the search region is extended until the extended search region covers the current frame image. When the target object in the current frame image for object tracking is blocked or the target object in the current frame image for object tracking leaves the field of view, the extended search region in the current frame image can be used to cover the entire current frame image, and when performing object tracking in the next frame image, the extended search region is used to cover the entire next frame image. When the target object appears in the next frame image, because the extended search region covers the entire next frame image, a situation in which the target object cannot be tracked since the target object appears outside the search region does not occur, and thus long-term tracking the target object can be realized.

In some embodiments, the search unit 650 is further configured to detect whether the filtering information of the target object is greater than a second predetermined threshold after determining the target object in the current frame image in the extended search region, wherein the second predetermined threshold is greater than the first predetermined threshold; if the filtering information of the target object is greater than the second predetermined threshold, obtain the search region in the current frame image; and/or, if the filtering information of the target object is less than or equal to the second predetermined threshold, use the next frame image adjacent to the current frame image in the video as a current frame image, and obtain the extended search region as the search region in the current frame image.

In this embodiment, when performing object tracking on the next frame image after the search region is extended according to the filtering information of the target object in the current frame image, the next frame image is taken as a current frame image, then the filtering information of the target object in the current frame image is compared with the second predetermined threshold, when the filtering information of the target object in the current frame image is greater than the second predetermined threshold, the search region in the current frame image is obtained, and the target object in the current frame image is determined within the search region. When the target object in the current frame image for object tracking is not blocked and the target object in the current frame image does not leave the field of view, the original object tracking method can be restored, that is, the predetermined search algorithm is used to obtain the search region in the current frame image for object tracking, thereby reducing the amount of data processing and increasing the calculation speed.

In some embodiments, the object tracking apparatus further includes an identification unit. After determining that the candidate object whose filtering information satisfies a predetermined condition is the target object in the current frame image, the identification unit can further identify the category of the target object in the current frame image, which can enhance the function of object tracking and increase the application scenarios of object tracking.

In some embodiments, the object tracking apparatus includes a neural network, and performs the object tracking method through the neural network.

Optionally, before executing the object tracking method, the neural network can be trained according to sample images. The sample images used for training the neural network may include positive samples and negative samples, where the positive samples include: positive sample images in a predetermined training data set and positive sample images in a predetermined test data set. For example, the predetermined training data set can use video sequences on Youtube BB and VID, and the predetermined test data set can use detection data from ImageNet and COCO. In this embodiment, by using positive sample images in the test data set to train the neural network, the types of positive samples can be increased, thereby ensuring the generalization performance of the neural network and improving the discrimination ability of object tracking.

Optionally, in addition to including the positive sample images in the predetermined training data set and the positive sample images in the predetermined test data set, the positive samples may further include: positive sample images obtained by performing data enhancement processing on the positive sample images in the predetermined test data set. For example, in addition to conventional data enhancement processing such as translation, scale change, and light change, data enhancement processing, such as motion blur, for a particular motion mode can be adopted. The manner of data enhancement processing is not limited in this embodiment. In this embodiment, the neural network is trained with positive sample images obtained by performing data enhancement processing on the positive sample images in the test data set, which can increase the diversity of positive sample images, improve the robustness of the neural network, and avoid overfitting.

Optionally, negative samples can include: a negative sample image of an object having the same category as the target object and/or a negative sample image of an object having different category from the target object. For example, the negative sample image obtained from the positive sample images in the predetermined test data set can be a background image around the target object in the positive sample image from the predetermined test data set. In this case, these two types of negative sample images usually have no semantics. The negative sample image of an object having the same category as the target object can be a frame image randomly extracted from other videos or images, and the object in the frame image has the same category as the target object in the positive sample image. The negative sample image of an object having a different category from the target object can be a frame image randomly extracted from other videos or images, and the object in the frame image has a different category from the target object in the positive sample image. In this case, these two types of negative sample images usually have semantics. In this embodiment, the neural network is trained by using the negative sample image of an object having the same category as the target object and/or the negative sample images of an object having a different category from the target object, which can ensure a balanced distribution of positive and negative sample images and improve the performance of the neural network, thereby improving the discrimination ability of object tracking.

In an optional example, since the “annotation data” of the training data obtained by other methods is relatively sparse, that is, the effective pixel value in the depth map is relatively less, the depth map obtained by binocular image stereo matching is used as the “annotation data” of the training data.

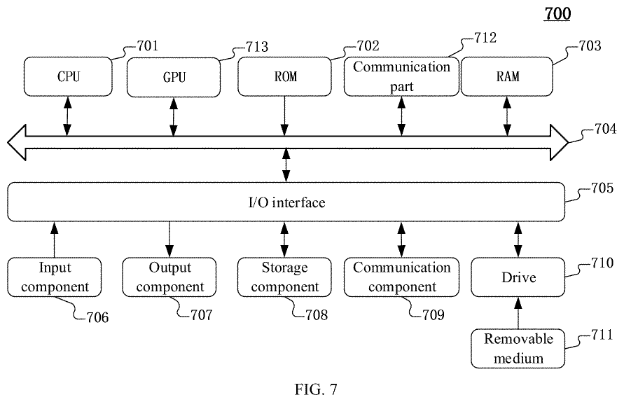

In addition, embodiments of the present disclosure further provide an electronic device, such as, a mobile terminal, a personal computer (PC), a tablet computer, a server, and the like. Referring to FIG. 7 below, which shows a schematic structural diagram of an electronic device 700 suitable for implementing a terminal device or a server according to embodiments of the present disclosure. As shown in FIG. 7, the electronic device 700 includes one or more processors, a communication part, and the like. The one or more processors may include, for example, one or more central processing units (CPUs) 701. and/or one or more image processors (GPUs) 713, etc. The processor may perform various appropriate actions and processes according to executable instructions stored in the read-only memory (ROM) 702 or executable instructions loaded from the storage component 708 into the random access memory (RAM) 703. The communication part 712 may include, but not limited to, a network card, and the network card may include, but not limited to, an IB (Infiniband) network card. The processor may communicate with ROM 702 and/or RAM 703 to execute executable instructions. The processor is coupled with the communication part 712 through the bus 704 and communicates with other target devices via the communication part 712. Thus, the operations corresponding to any method provided by embodiments of the present disclosure is completed. For example, the operations include detecting, according to a target object in a reference frame image in a video, at least one candidate object in a current frame image in the video; obtaining an interference object in at least one previous frame image in the video; adjusting filtering information of the at least one candidate object according to the obtained interference object; and determining one of the at least one candidate object whose filtering information satisfies a predetermined condition as the target object in the current frame image.

In addition, the RAM 703 can further store various programs and data required for apparatus operation. The CPU 701, the ROM 702, and the RAM 703 are coupled with each other via the bus 704. In the case where the RAM 703 is present, the ROM 702 is an optional module. The RAM 703 is to store executable instructions, or write executable instructions into the ROM 702 when running, and the executable instructions cause CPU 701 to execute operations corresponding to the above object tracking methods. The input/output (I/O) interface 705 is also coupled to the bus 704. The communication part 712 may be integrally arranged, or may be arranged to have a plurality of sub-modules (for example, a plurality of IB network cards) and be linked to the bus.

The following components are connected to the I/O interface 705: an input component 706 including a keyboard, a mouse, etc; an output component 707 including, for example, a cathode ray tube (CRT), a liquid crystal display (LCD), a speaker and the like; a storage component 708 including a hard disk or the like; and a communication component 709 including a network interface card such as a local area network (LAN) card, a modem or the like. The communication component 709 performs communication processing via a network such as Internet. The driver 710 is also connected to I/O interface 705 as needed. A removable medium 711, such as a magnetic disk, an optical disk, a magneto-optical disk, a semiconductor memory, or the like, is mounted on the driver 710 as needed, so that a computer program read out from the removable medium 711 is mounted into the storage component 708 as needed.

It should be noted that the architecture shown in FIG. 7 is merely an optional implementation, and during practice, the number and type of the components shown in FIG. 7 may be selected, deleted, added or replaced according to actual needs. Implementations such as separation setting or integration setting may also be adopted on different functional component settings, for example, the GPU 713 and the CPU 701 may be separately set or the GPU 713 may be integrated on the CPU 701, the communication part may be separately set, or may be integrated on the CPU 701 or the GPU 713, etc. These alternative embodiments all belong to the scope of protection of the present disclosure.

In particular, according to embodiments of the present disclosure, the processes described above with reference to the flowcharts may be implemented as computer software programs. For example, embodiments of the present disclosure include a computer program product including a computer program tangibly embodied on a machine readable medium. The computer program includes program codes for executing the methods shown in the flowcharts. The program codes may include instructions for executing the method steps provided in the embodiments of the present disclosure. For example, the method steps include: detecting, according to a target object in a reference frame image in a video, at least one candidate object in a current frame image in the video; obtaining an interference object in at least one previous frame image in the video; adjusting filtering information of the at least one candidate object according to the obtained interference object; and determining one of the at least one candidate object whose filtering information satisfies a predetermined condition as the target object in the current frame image. In such embodiments, the computer program may be downloaded and installed from the network through the communication component 709 and/or installed from the removable medium 711. When the computer program is executed by CPU 701, the above-described functions defined in the methods of the present disclosure are executed.

In one or more optional implementations, embodiments of the present disclosure further provide a computer program product for storing computer-readable instructions. When the computer-readable instructions are executed, the computer is caused to execute the object tracking method described by any of the foregoing possible implementations.

The computer program product can be implemented by hardware, software or a combination thereof. In an optional example, the computer program product is embodied as a computer storage medium. In another optional example, the computer program product is embodied as a software product, such as a Software Development Kit (SDK) and so on.

In one or more optional implementations, the embodiments of the present disclosure further provide an object tracking method and corresponding apparatus, electronic device, computer storage medium, computer program, and computer program product, wherein the method includes that: a first apparatus sends an object tracking instruction to a second apparatus, which causes the second apparatus to execute the object tracking method in any of the above possible embodiments; the first apparatus receives the object tracking result sent by the second apparatus.

In some embodiments, the object tracking instruction may be a calling instruction, and the first apparatus may instruct the second apparatus to perform object tracking by calling. Accordingly, in response to receiving the calling instruction, the second apparatus may execute steps and/or processes of the object tracking method in any of the above embodiments.

It should be understood that terms such as “first” and “second” in the embodiments of the present disclosure are merely for distinguishing, and should not be construed as limiting the embodiments of the present disclosure.

It should also be understood that in the present disclosure, “a plurality of” may refer to two or more, and “at least one” may refer to one, two or more.

It should also be understood that any of the components, data or structures mentioned in the present disclosure may generally be understood as one or more of the components, data or structures without expressly defining or giving the opposite motivation in the context.

It should also be understood that the description of various embodiments of the present disclosure focuses on emphasizing differences between various embodiments, and the same or similar points may be referred to each other. For simplicity, the same or similar parts will not be described herein again.

Various embodiments in the present description are described in a progressive manner, and the emphasizing description of each embodiment is different from the other embodiments, and the same or similar parts between various embodiments may be referred to each other. For the system embodiment, since the system embodiment substantially corresponds to the method embodiment, the description is relatively simple, and reference may be made to some of the description of the method embodiment.

The methods and apparatuses of the present disclosure may be implemented in many ways. For example, the methods and apparatuses of the present disclosure may be implemented by software, hardware, firmware, or any combination of software, hardware, firmware. The above-mentioned order of steps for the methods is for illustration only, and the steps of the methods of the present disclosure are not limited to the order described above unless otherwise specifically stated. Furthermore, in some embodiments, the present disclosure may also be embodied as programs recorded in a recording medium, including machine-readable instructions for implementing the methods according to the present disclosure. Accordingly, the present disclosure also covers a recording medium storing a program for executing the methods according to the present disclosure.

The descriptions of the present disclosure are given for purposes of example and description and are not omissive or limit the present disclosure to the disclosed forms. Many modifications and variations will be apparent to those skilled in the art. The embodiments are chosen and described for better illustration of the principles and practical applications of the present disclosure, and to enable those skilled in the art to understand the present disclosure to design various embodiments with various modifications suitable for a particular use.

1. An object tracking method, comprising:
detecting, according to a target object in a reference frame image in a video, at least one candidate object in a current frame image in the video;
obtaining an interference object in at least one previous frame image in the video;
adjusting filtering information of the at least one candidate object according to the obtained interference object; and
determining one of the at least one candidate object whose filtering information satisfies a predetermined condition as the target object in the current frame image.

2. The method according to claim 1, wherein the current frame image in the video is after the reference frame image;
the at least one previous frame image includes: the reference frame image, and/or at least one intermediate frame image located between the reference frame image and the current frame image.

3. The method according to claim 1, further comprising:
determining one or more of the at least one candidate object as interference objects in the current frame image, the one or more of the at least one candidate object not being determined as the target object.

4. The method according to claim 1, wherein adjusting the filtering information of the at least one candidate object according to the obtained interference object comprises:
for each of the at least one candidate object,
determining a first similarity between the candidate object and the obtained interference object; and
adjusting the filtering information of the candidate object according to the first similarity.

5. The method according to claim 4, wherein determining the first similarity between the candidate object and the obtained interference object comprises:
determining the first similarity according to a feature of the candidate object and a feature of the obtained interference object.

6. The method according to claim 1, further comprising:
obtaining the target object in at least one intermediate frame image between the reference frame image and the current frame image in the video; and
optimizing the filtering information of the at least one candidate object according to the target object in the at least one intermediate frame image.

7. The method according to claim 6, wherein optimizing the filtering information of the at least one candidate object according to the target object in the at least one intermediate frame image comprises:
for each of the least one candidate object,
determining a second similarity between the candidate object and the target object in the at least one intermediate frame image; and
optimizing the filtering information of the candidate object according to the second similarity.

8. The method according to claim 7, wherein determining the second similarity between the candidate object and the target object in the at least one intermediate frame image comprises:
determining the second similarity according to a feature of the candidate object and a feature of the target object in the at least one intermediate frame image.

9. The method according to claim 1, wherein detecting at least one candidate object in the current frame image in the video according to the target object in the reference frame image in the video comprises:
determining a correlation between an image of the target object in the reference frame image and the current frame image; and
obtaining bounding boxes and the filtering information of the at least one candidate object in the current frame image according to the correlation.

10. The method according to claim 9, wherein determining the correlation between the image of the target object in the reference frame image and the current frame image comprises:
determining the correlation according to a first feature of the image of the target object in the reference frame image and a second feature of the current frame image.

11. The method according to claim 9, wherein determining one of the at least one candidate object whose filtering information satisfies the predetermined condition as the target object in the current frame image comprises:
determining a bounding box of the one of the at least one candidate object whose filtering information satisfies the predetermined condition as a bounding box of the target object in the current frame image.

12. The method according to claim 11, further comprising: after determining the bounding box of the candidate object whose filtering information satisfies the predetermined condition as the bounding box of the target object in the current frame image,
displaying the bounding box of the target object in the current frame image.

13. The method according to claim 1, further comprising: before detecting at least one candidate object in the current frame image in the video according to the target object in the reference frame image in the video,
obtaining a search region in the current frame image;
detecting at least one candidate object in the current frame image in the video according to the target object in the reference frame image in the video comprises:
detecting, within the search region in the current frame image and according to the target object in the reference frame image in the video, the at least one candidate object in the current frame image in the video.

14. The method according to claim 1, further comprising: after determining one of the at least one candidate object whose filtering information satisfies the predetermined condition as the target object in the current frame image,
determining a search region in a next frame image adjacent to the current frame image in the video according to filtering information of the target object in the current frame image.

15. The method according to claim 14, wherein determining the search region in the next frame image adjacent to the current frame image in the video according to the filtering information of the target object in the current frame image comprises:
detecting whether the filtering information of the target object is less than a first predetermined threshold;
in response to determining that the filtering information of the target object is less than the first predetermined threshold, gradually extending the search region according to a predetermined step length until the extended search region covers the current frame image, and using the extended search region as the search region in the next frame image adjacent to the current frame image; and/or
in response to determining that the filtering information of the target object is greater than or equal to the first predetermined threshold, taking the next frame image adjacent to the current frame image in the video as a current frame image, and obtaining a search region in the current frame image.

16. The method according to claim 15, further comprising: after gradually extending the search region according to the predetermined step length until the extended search region covers the current frame image,
taking the next frame image adjacent to the current frame image in the video as a current frame image;
determining the target object in the current frame image within the extended search region;
detecting whether filtering information of the target object is greater than a second predetermined threshold; wherein the second predetermined threshold is greater than the first predetermined threshold;
in response to determining that the filtering information of the target object is greater than the second predetermined threshold, obtaining a search region in the current frame image; and/or
in response to determining that the filtering information of the target object is less than or equal to the second predetermined threshold, taking a next frame image adjacent to the current frame image in the video as a current frame image, and obtaining the extended search region as a search region in the current frame image.

17. The method according to claim 1, further comprising: after determining one of the at least one candidate object whose filtering information satisfies the predetermined condition as the target object in the current frame image,
identifying a category of the target object in the current frame image.

18. The method according to claim 1, wherein the object tracking method is performed by a neural network, the neural network is trained by using sample images, the sample images comprise positive samples and negative samples, and the positive samples comprise: positive sample images in a predetermined training data set and positive sample images in a predetermined test data set.

19. An electronic device, comprising:
a memory storing executable instructions; and
a processor configured to execute the executable instructions, when executing the executable instructions, the processor is caused to perform operations comprising:
detecting, according to a target object in a reference frame image in a video, at least one candidate object in a current frame image in the video;
obtaining an interference object in at least one previous frame image in the video;
adjusting filtering information of the at least one candidate object according to the obtained interference object; and
determining one of the at least one candidate object whose filtering information satisfies a predetermined condition as the target object in the current frame image.

20. A non-transitory computer storage medium for storing computer-readable instructions, when the computer-readable instructions are executed by a processor, the processor is caused to perform operations comprising:
detecting, according to a target object in a reference frame image in a video, at least one candidate object in a current frame image in the video;
obtaining an interference object in at least one previous frame image in the video;
adjusting filtering information of the at least one candidate object according to the obtained interference object; and
determining one of the at least one candidate object whose filtering information satisfies a predetermined condition as the target object in the current frame image.
